(19) United States
(12) Patent Application Publication
(10) Pub. No.: US 2011/0305211 A1
(43) Pub. Date: Dec. 15, 2011

(54) ADVANCED RESOURCE ALLOCATION SIGNALING

(75) Inventors: Timo Erkki Lunttila, Espoo (FI); Timo Eric Roman, Espoo (FI); Tommi Tapani Koivisto, Espoo (FI)

(73) Assignee: NOKIA CORPORATION, Espoo (FI)

(21) Appl. No.: 13/121,028

(22) PCT Filed: Sep. 25, 2008
(86) PCT No.: PCT/IB2008/053914

§ 371 Date: Mar. 25, 2011

(51) Int. Cl. H04W 72/04

(52) U.S. Cl. 370/329

(57) ABSTRACT

Disclosed is a method, apparatus and a computer readable memory medium that stores a program of computer instructions for enabling a resource allocation to be made for user equipment. The method includes forming a resource allocation for a particular system bandwidth, where the resource allocation has a larger number of resource blocks than a maximum number of resource blocks associated with the particular system bandwidth, while maintaining a same resource block group size as would be present with the maximum number of resource blocks for the particular system bandwidth. The step of forming includes the use of an extended parameter in a derivation of the resource allocation. The method further includes transmitting information descriptive of the resource allocation to user equipment. The resource allocation may be a downlink resource allocation or an uplink resource allocation.

### TECHNICAL FIELD

The exemplary and non-limiting embodiments of this invention relate generally to wireless communication systems, methods, devices and computer programs and, more specifically, relate to the allocation of wireless communication resources to user equipment.

### BACKGROUND

The following abbreviations that may be found in the specification and/or drawing figures are defined as follows: 3GPP third generation partnership project UTRAN universal terrestrial radio access network LTE long term evolution Node B base station eNB EUTRAN Node B (evolved Node B) UE user equipment UL uplink (UE towards eNB DL downlink (eNB towards UE) FDD frequency division duplex MME mobility management entity S-GW serving gateway PRB physical resource block PHY physical layer 1) RRC radio resource control BW bandwidth OFDMA orthogonal frequency division multiple access SC-FDMA single carrier, frequency division multiple access DCI downlink control information PBCH physical broadcast channel PDCCH physical downlink shared channel PRB physical resource block RB resource block RBG resource block group RE resource element RS reference symbol MIB master information block SIB system information block MBSFN multicast-broadcast single frequency network CQI channel quality indicator TBS transport block size MCS modulation coding scheme

A communication system known as evolved UTRAN (EUTRAN, also referred to as UTRAN-LTE or as E-UTRA) is under development within the 3GPP. As specified the DL access technique will be OFDMA, and the UL access technique will be SC-FDMA.

One specification of interest is 3GPP TS 36.300, V8.5.0 (2008-05), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein in its entirety. The described system may be referred to for convenience as LTE Rel. 8, or simply as Rel. 8. In general, the set of specifications given generally as 3GPP TS 36.xyz (e.g., 36.104, 36.211, 36.312, etc.) may be seen as describing the entire Rel. 8 LTE system.

Of further interest herein are the following specifications:
3GPP TS 36.101 V8.1.0 (2008-03) Technical Specification 3rd Generation Partnership Project; Technical Specification Group Radio Access Network; Evolved Universal Terrestrial Radio Access (E-UTRA); User Equipment (UE) radio transmission and reception (Release 8);
3GPP TS 36.104 V8.1.0 (2008-03) Technical Specification 3rd Generation Partnership Project; Technical Specification Group Radio Access Network; Evolved Universal Terrestrial Radio Access (E-UTRA); Base Station (BS) radio transmission and reception (Release 8);
3GPP TS 36.211 V8.3.0 (2008-05) Technical Specification 3rd Generation Partnership Project; Technical Specification Group Radio Access Network; Evolved Universal Terrestrial Radio Access (E-UTRA); Physical Channels and Modulation (Release 8); and
3GPP TS 36.213 V8.3.0 (2008-05) Technical Specification 3rd Generation Partnership Project; Technical Specification Group Radio Access Network; Evolved Universal Terrestrial Radio Access (E-UTRA); Physical layer procedures (Release 8),
   all of which are incorporated by reference herein.

Also of interest herein are further releases of 3GPP LTE targeted towards future wireless communication systems, which may be referred to herein for convenience simply as LTE-Advanced (LTE-A), or as Rel. 9, or as Rel. 10. For example, reference can be made to 3GPP TR 36.913, V8.0.0 (2008-06), 3rd Generation Partnership Project; Technical Specification Group Radio Access Network; Requirements for Further Advancements for E-UTRA (LTE-Advanced) (Release X), also incorporated by reference herein in its entirety.

In accordance with 3GPP TS 36.104 and 3GPP TS 36.101 only selected DL and UL system BWs are supported by Rel. 8. For FDD these BWs are 1.4 MHz, 3 MHz, 5 MHz, 10 MHz, 15 MHz, and 20 MHz. The standardized system bandwidths are shown in Table 5.1-1 of 3GPP TS 36.104 v8.1.0, reproduced herein as FIG. 1.

It may be desirable in some circumstances to enable a better utilization of an arbitrary spectrum allocation in terms of BW (MHz). For example, it may be the case that a certain network operator has, for example, 11 MHz of spectrum available. According to Rel. 8, the operator may place on that band (at most) the 10 MHz LTE carrier, leaving the remaining 1 MHz unused (at least for LTE).

In principle it may be possible to achieve any transmission BW for data with LTE Rel. 8. For example, and using the values of the preceding paragraph, one may instead of using the 10 MHz system BW use the 15 MHz system BW, and simply not allocate data to the band edges, leaving only 11 MHz of the 15 MHz for the data. However, in 3GPP it has been agreed that the physical downlink control channel (PDCCH) occupies the entire system band (1.4, 3, 5, 10, 15, or 20 MHz). Thus, even if spectrum used for data transmission is reduced from 15 MHz to 11 MHz (in this non-limiting example), the PDCCH would still require the use of the entire 15 MHz BW, thereby exceeding the operator's allocated share of frequency resources. It can thus be appreciated that it is not currently possible to address a larger bandwidth than that used for the PDCCH with DCI formats as defined for LTE. Rel. 8.

### SUMMARY

The foregoing and other problems are overcome, and other advantages are realized, by the use of the exemplary embodiments of this invention.

In a first aspect thereof the exemplary embodiments of this invention provide a method that includes forming a downlink resource allocation for a particular downlink system bandwidth, where the downlink resource allocation comprises a larger number of resource blocks than a maximum number of resource blocks associated with the particular downlink system bandwidth, while maintaining a same resource block group size as would be present with the maximum number of resource blocks with the particular downlink system bandwidth. The step of forming comprises use of an extended parameter in a derivation of the resource allocation. The method further includes transmitting information descriptive of the downlink resource allocation to user equipment.

In another aspect thereof the exemplary embodiments of this invention provide a computer-readable memory medium that stores program instructions, the execution of which results in operations that comprise forming a resource allocation for a particular system bandwidth, where the resource allocation comprises a larger number of resource blocks than a maximum number of resource blocks associated with the particular system bandwidth while maintaining a same resource block group size as would be present with the maximum number of resource blocks for the particular system bandwidth. The operation of forming comprises the use of an extended parameter in a derivation of the resource allocation. A further operation transmits information descriptive of the resource allocation to user equipment.

In a further aspect thereof the exemplary embodiments of this invention provide an apparatus that comprises a resource allocation unit configured to form a resource allocation for a particular system bandwidth, where the resource allocation comprises a larger number of resource blocks than a maximum number of resource blocks associated with the particular system bandwidth while maintaining a same resource block group size as would be present with the maximum number of resource blocks for the particular system bandwidth. The resource allocation is configured to use an extended parameter in a derivation of the resource allocation. The resource allocation unit is further configured to be coupled with a transmitter to transmit information descriptive of the resource allocation to user equipment.

In a further aspect thereof the exemplary embodiments of this invention provide an apparatus that comprises means for forming a resource allocation for a particular system bandwidth, where the resource allocation comprises a larger number of resource blocks than a maximum number of resource blocks associated with the particular system bandwidth while maintaining a same resource block group size as would be present with the maximum number of resource blocks for the particular system bandwidth. Said means for forming uses of an extended parameter in a derivation of the resource allocation. The apparatus further includes means for transmitting information descriptive of the resource allocation to user equipment. A first extended parameter is one that expresses a downlink bandwidth configuration in multiples of a resource block size in the frequency domain, expressed as a number of frequency subcarriers, and effectively scales the resource allocation field to provide a larger downlink system bandwidth than that provided by the particular downlink system bandwidth. A second extended parameter is one that expresses an uplink bandwidth configuration in multiples of a resource block size in the frequency domain, expressed as a number of frequency subcarriers, and effectively scales the resource allocation field to provide a larger uplink system bandwidth than that provided by the particular uplink system bandwidth.

In yet another aspect thereof the exemplary embodiments of this invention provide an apparatus that comprises a receiver configured with a controller to receive one or both of a first extended parameter and a second extended parameter, where the first extended parameter is indicative of a downlink bandwidth configuration in multiples of a resource block size in the frequency domain, expressed as a number of frequency subcarriers, and where the second extended parameter is indicative of an uplink bandwidth configuration in multiples of a resource block size in the frequency domain, expressed as a number of frequency subcarriers. The first and second extended parameters comprise a part of a resource allocation having a larger number of resource blocks than a maximum number of resource blocks associated with a particular system bandwidth, while maintaining a same resource block group size as would be present with the maximum number of resource blocks for the particular system bandwidth.

### BRIEF DESCRIPTION OF THE DRAWINGS

In the attached Drawing Figures:

FIG. 1 reproduces Table 5.1-1 of 3GPP TS 36.104 v8.1.0, and shows LTE Rel. 8 system bandwidth options.

FIG. 2 shows a simplified block diagram of various electronic devices that are suitable for use in practicing the exemplary embodiments of this invention.

FIG. 3 shows an extended PDSCH RB space that is addressed by the signaling technique in accordance with the exemplary embodiments of this invention.

FIG. 4A reproduces Table 7.1.6.1-1 from 3GPP TS 36.213, and shows the Type 0 Resource Allocation RBG Size vs. Downlink System Bandwidth.

FIG. 4B reproduces FIG. 6.2.2-1: Downlink Resource Grid, from 3GPP TS 36.211.

FIG. 4C reproduces FIG. 5.2.1-1: Uplink Resource Grid, from 3GPP TS 36.211.

FIG. 5 shows exemplary values for a parameter N_{RB}_{_{—}}ₑₓₜ^{DL} used with different system bandwidths.

FIG. 6 is a logic flow diagram that illustrates the operation of a method, and a result of execution of computer program instructions, in accordance with the exemplary embodiments of this invention.

### DETAILED DESCRIPTION

The exemplary embodiments of this invention pertain at least in part to the Layer 1 (PHYS) specifications (generally 3GPP 36.2XX), and are particularly useful for LTE releases “beyond Rel. 8” (e.g., Rel-9, Rel-10 or LTE-Advanced). More specifically these exemplary embodiments pertain at least in part to DL resource allocation signaling to support larger bandwidths.

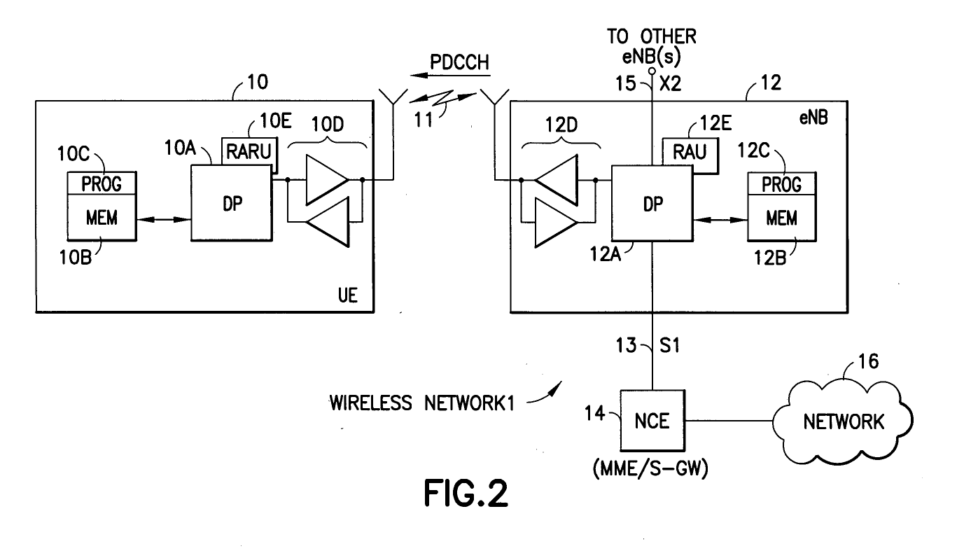

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication with an apparatus, such as a mobile communication device which may be referred to as a UE 10, via a network access node, such as a Node B (base station), and more specifically an eNB 12. The network 1 may include a network control element (NCE) 14 that may include MME/S-GW functionality, and which provides connectivity with a network 16, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for conducting bidirectional wireless communication 11 with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas The eNB 12 is coupled via a data/control path 13 to the NCE 14. The path 13 may be implemented as an Si interface. At least the PROG 12C is assumed to include program instructions that, when executed by the associated DP 12A, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the eNB 12, or by hardware, or by a combination of software and hardware.

For the purposes of describing the exemplary embodiments of this invention the eNB 12 may be assumed to also include a resource allocation unit (RAU) 12E that operates in accordance with the exemplary embodiments of this invention so as to consider a new parameter N_{RB}_{_{—}}ₑₓₜ^{DL} that indicates how many DL RBs can be assigned with the DL grant in the PDCCH, as described below. The parameter N_{RB}_{_{—}}ₑₓₜ^{DL} is assumed to be equal to or greater than a nominal (or specified) DL BW that equals N_{RB}^{DL} resource blocks. The RAU 12E may be implemented in hardware, software (e.g., as part of the program 12C), or as a combination of hardware and software (and firmware). As will be discussed below the RAU 12E can also be configured to consider a second new parameter N_{RB}_{_{—}}ₑₓₜ^{UL} that indicates how many UL RBs can be assigned with the UL grant in the PDCCH. The RAU 12E may be embodied entirely, or at least partially, in one or more integrated circuit packages or modules.

It should thus be appreciated that the UE 10 is configured to include a resource allocation reception unit (RARU) 10E that operates in accordance with the exemplary embodiments of this invention so as to receive and consider one or both of the new parameters N_{RB}_{_{—}}ₑₓₜ^{DL} and N_{RB}_{_{—}}ₑₓₜ^{UL}. The RARU 10E may be embodied entirely, or at least partially, in one or more integrated circuit packages or modules.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A may be of any type suitable to the local technical environment, and may include one or more of general purpose computers, special purpose computers, microprocessors, digital signal processors (DSPs) and processors based on multi-core processor architectures, as non-limiting examples.

As considered herein a “beyond Rel. 8” UE 10 is one configured for operation with a release or releases of LTE such as, for example, Rel. 9, Rel. 10, LTE-Advanced, etc. Note that a beyond Rel. 8 UE 10 may also be backward compatible with Rel. 8, and may furthermore be a multi-mode type of device that is capable of operation with another type or types of wireless standards/protocols, such as GSM.

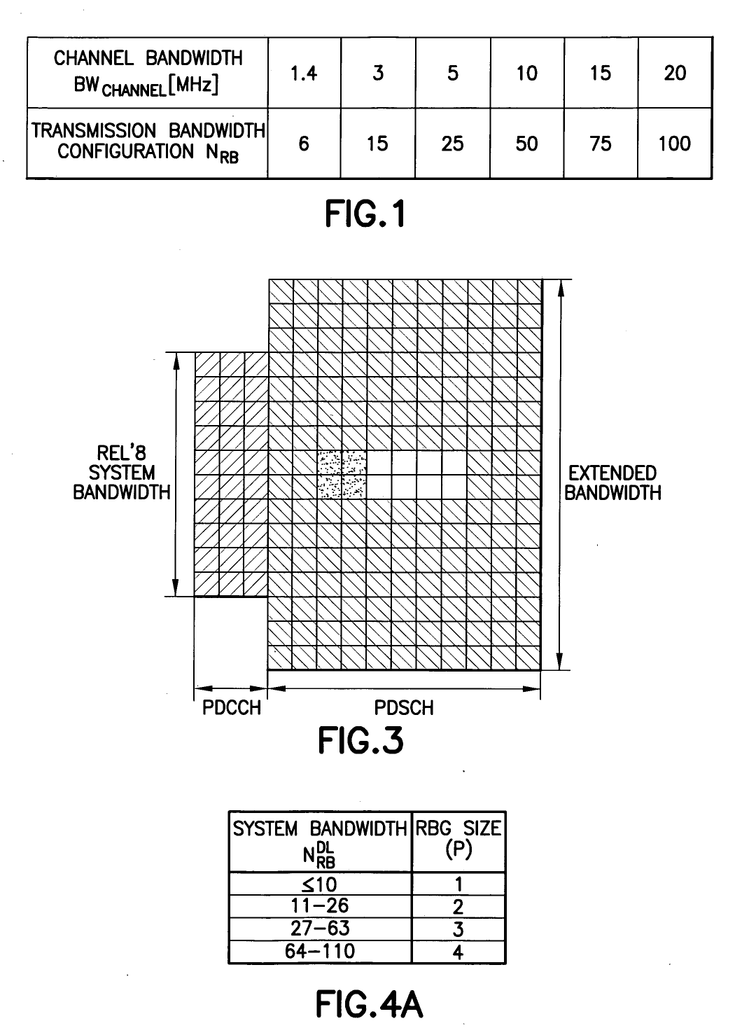

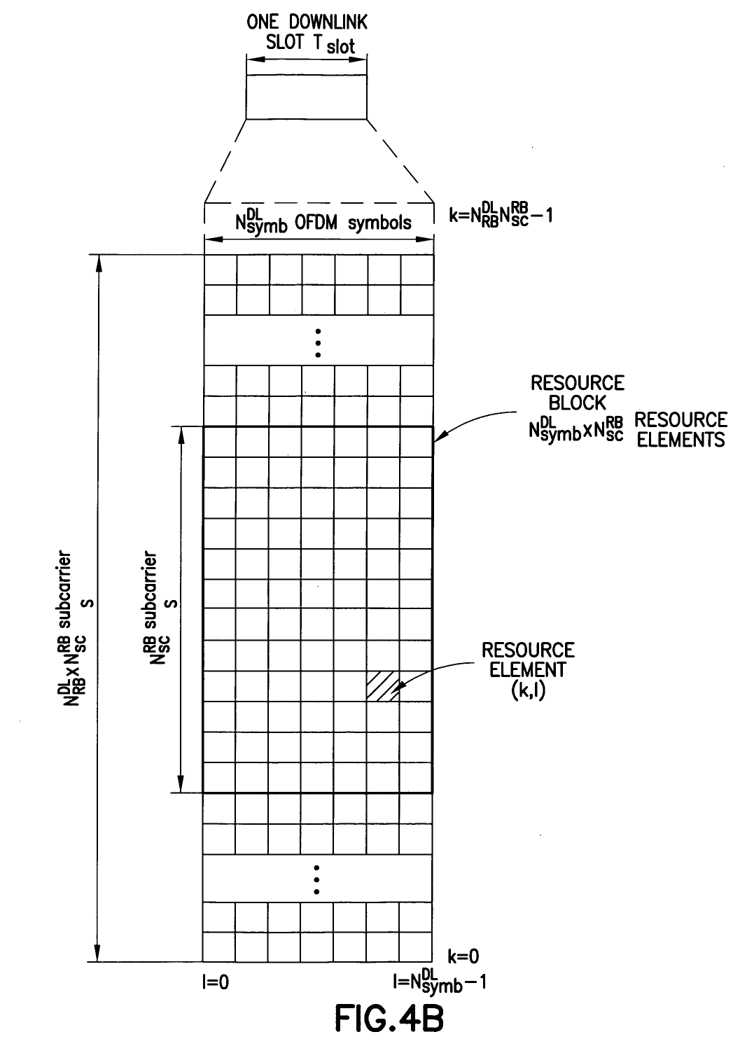

The exemplary embodiments of this invention provide a mechanism and process to allocate resources outside of a nominal system BW, such as the exemplary BWs listed in FIG. 1. This is illustrated in FIG. 3, which shows an extended PDSCH RB space that is addressed by the signaling technique in accordance with the exemplary embodiments of this invention. The use of these exemplary embodiments involves a modification to the DL grants on the PDCCH to achieve a more flexible resource allocation. However, pre-existing definitions and formulas of current specifications are retained to the largest extent possible.

It should be noted that while the exemplary embodiments of this invention are described in large part in the context of DL resource allocations, the exemplary embodiments apply equally to UL resource allocations.

3GPP 36.211 defines certain parameters of interest herein as follows:

N_{RB}^{UL} downlink bandwidth configuration, expressed in multiples of N_{sc}^{RB};
N_{RB}^{min, DL} smallest downlink bandwidth configuration, expressed in multiples of N_{sc}^{RB};
N_{RB}^{max, DL} largest downlink bandwidth configuration, expressed in multiples of N_{sc}^{RB};
N_{sc}^{RB} resource block size in the frequency domain, expressed as a number of subcarriers;
N_{RB}^{DL} uplink bandwidth configuration, expressed in multiples of N_{sc}^{RB};
N_{RB}^{min, UL} smallest uplink bandwidth configuration, expressed in multiples of N_{sc}^{RB};
N_{RB}^{max, UL} RB largest uplink bandwidth configuration, expressed in multiples of N_{sc}^{RB};

Typically it is not assumed that N_{RB}^{UL} is equal to N N_{RB}^{DL}.

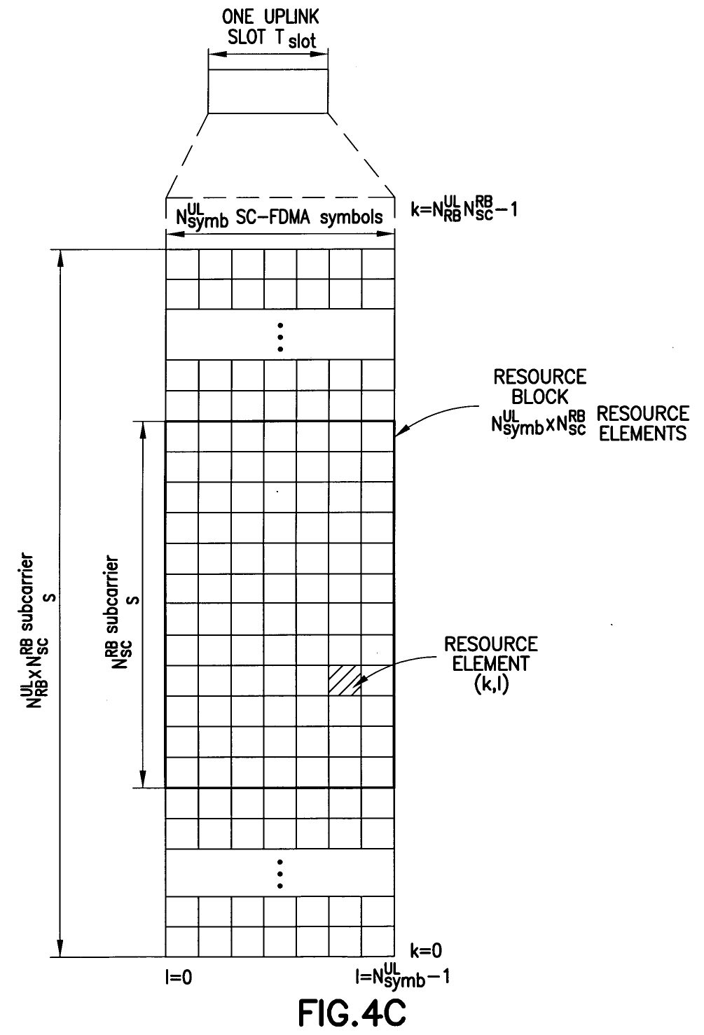

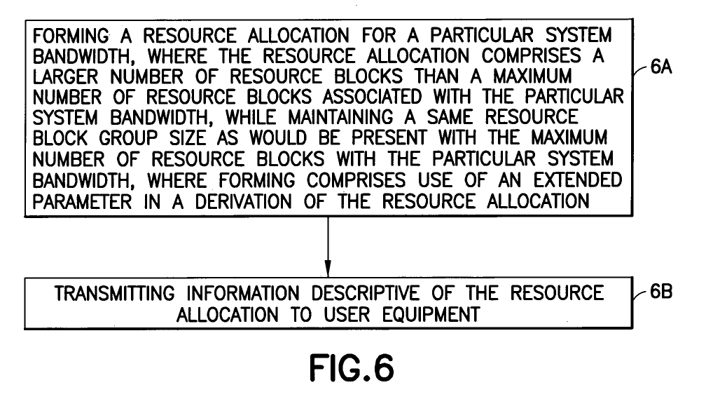

One important parameter regarding resource allocation in LTE is the granularity, i.e., the RBG size. The resource allocation granularities in the LTE have been defined in Table 7.1.6.1-1 in 3GPP TS 36.213, reproduced herein as FIG. 4A. The RBG size defines the minimum number of consecutive resource blocks (RB) that can be allocated to a single user (to a single UE 10) when resource allocation type 0 is used. In LTE one RB consists of 12 consecutive frequency subcarriers. Reference in this regard may be made to FIG. 4B, which reproduces FIG. 6.2.2-1: Downlink Resource Grid, from 3GPP TS 36.211.

Subclause 6.2.1 of 3GPP TS 36.211, “Resource grid”, states that the transmitted signal in each slot is described by a resource grid of N_{RB}^{DL}N_{sc}^{RB} subcarriers and N_{symb}^{DL} OFDM symbols. The resource grid structure is illustrated in FIG. 6.2.2-1, reproduced herein as FIG. 4B. The quantity N_{RB}^{DL} depends on the downlink transmission bandwidth configured in the cell and shall fulfil

N_{RB}^{min, DL}≦N_{TB}^{DL}≦N_{RB}^{max, DL}

where N_{RB}^{min, DL}=6 and N_{RB}^{DL}=110 are the smallest and largest downlink bandwidth, respectively, supported by the current version of this specification (the Rel. 8 LTE specification).

The set of allowed values for N_{RB}^{DL} is given by 3GPP TS 36.104. The number of OFDM symbols in a slot depends on the cyclic prefix length and subcarrier spacing configured and is given in Table 6.2.3-1 of 3GPP TS 36.211.

In the case of multi-antenna transmission there is one resource grid defined per antenna port. An antenna port is defined by its associated reference signal. The set of antenna ports supported depends on the reference signal configuration in the cell:

(a) Cell-specific reference signals, associated with non-MBSFN transmission, support a configuration of one, two, or four antenna ports and the antenna port number p shall fulfil p=0, pε{0, 1}, and pε{0, 1, 2, 3}, respectively.
(b) MBSFN reference signals, associated with MBSFN transmission, are transmitted on antenna port p=4.
(c) UE-specific reference signals are transmitted on antenna port p=5.

Subclause 6.2.2, of 3GPP TS 36.211, “Resource elements”, states that each element in the resource grid for antenna port p is called a resource element and is uniquely identified by the index pair (k, l) in a slot where k=0, . . . , N_{RB}^{DL}N_{sc}^{RB}−1 and l=N_{symb}^{DL}−1 are the indices in the frequency and time domains, respectively. Resource element (k, l) on antenna port p corresponds to the complex value a_{k,l}^{(p)}.

Subclause 6.2.3, of 3GPP TS 36.211, “Resource blocks”, states in part that resource blocks are used to describe the mapping of certain physical channels to resource elements. Physical and virtual resource blocks are defined.

A physical resource block is defined as N_{symb}^{DL} consecutive OFDM symbols in the time domain and N_{sc}^{RB} consecutive subcarriers in the frequency domain, where N_{symb}^{DL} and N_{sc}^{RB} are given by Table 6.2.3-1. A physical resource block thus consists of N_{symb}^{DL}×N_{sc}^{RB} resource elements, corresponding to one slot in the time domain and 180 kHz in the frequency domain.

Physical resource blocks are numbered from 0 to N_{RB}^{DL}−1 in the frequency domain. The relation between the physical resource block number n_{PRB} in the frequency domain and resource elements (k, l) in a slot is given by

$${n}_{PRB} = ⌊ \frac{k}{{N}_{sc}^{RB}} ⌋ .$$

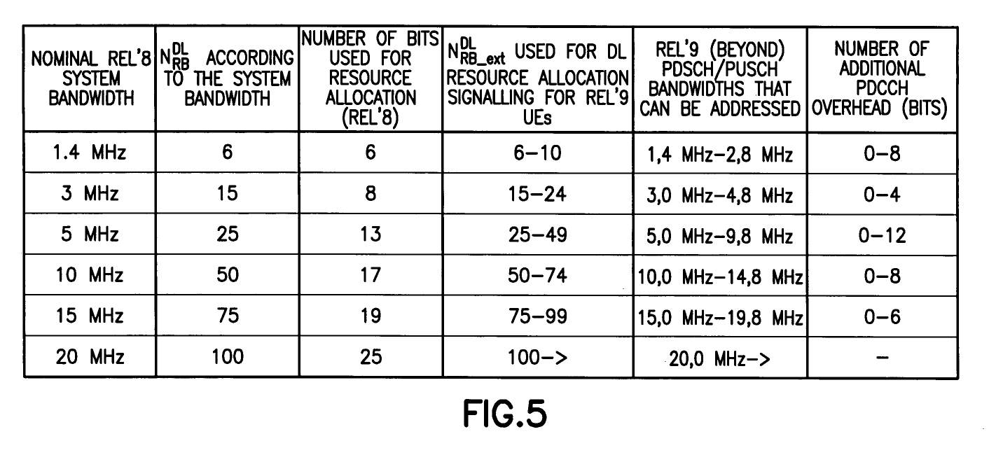

For completeness, subclause 5.2.1 of 3GPP 36.211 defines for the UL that the transmitted signal in each slot is described by a resource grid of N_{RB}^{UL}NR_{sc}^{RB} subcarriers and N_{symb}^{UL}, SC-FDMA symbols. The resource grid is illustrated in FIG. 5.2.1-1 and is reproduced herein as FIG. 4C. The quantity N_{RB}^{UL} depends on the uplink transmission bandwidth configured in the cell and shall fulfil

N_{RB}^{min, UL}≦N_{RB}^{UL} N_{RB}^{max, UL}

where N_{RB}^{min, UL}=6 and N_{RB}^{max, UL}=110 is the smallest and largest uplink bandwidth, respectively, supported by the current version of this specification. The set of allowed values for N_{RB}^{UL} is given by 3GPP 36.104. The number of SC-FDMA symbols in a slot depends on the cyclic prefix length configured by higher layers and is given in Table 5.2.3-1 of 3GPP TS 36.211.

The exemplary embodiments of this invention use the resource allocation according to a larger number of RBs (e.g., maximum) than the number N_{RB}^{DL} actually used with a particular system bandwidth, while maintaining the same RBG size P, i.e., the same granularity. This may be achieved by defining another parameter that is used in the derivation of the resource allocation field, i.e., a parameter other than N_{RB}^{DL}. This newly defined parameter may be referred for convenience, and not as a limitation, as N_{RB}_{_{—}}ₑₓₜ^{DL}.

In accordance with the exemplary embodiments the new parameter N_{RB}_{_{—}}ₑₓₜ^{DL} is defined to indicate how many DL RBs can be assigned with the DL grant in the PDCCH. This parameter replaces the parameter N_{RB}^{DL} in the specification of the resource allocation field of the DL grant for those UEs 10 that are compatible with operation beyond Rel. 8 (e.g., LTE-A). The use of the new parameter N_{RB}_{_{—}}ₑₓₜ^{DL} effectively scales the resource allocation field so that extended bandwidths can be addressed. The parameter N_{RB}_{_{—}}ₑₓₜ^{DL} may be static, or it may be signaled to the UE 10 using, as a non-limiting example, the MIB on the PBCH, or in a specific SIB (one defined for use with LTE-A). It is also within the scope of these embodiments to make the new parameter N_{RB}_{_{—}}ₑₓₜ^{DL} UE-specific, i.e., to configure the extended bandwidth operation separately for each UE 10 by using higher layer signaling (e.g., via RRC signaling).

Several non-limiting examples are now provided to illustrate the use, and the utility, of the exemplary embodiments of this invention.

### Example 1

With a system bandwidth of 10 MHz=50 PRBs, the resource allocation for beyond Rel. 8 UEs may be accomplished assuming a value of N_{RB}_{_{—}}ₑₓₜ^{DL} of up to 63 PRBs, while beneficially preserving the same resource allocation granularity. This allows for flexible utilization of larger available BWs of up to 63 PRBs with minimal modifications being needed to the existing specifications. The only change involves a slight increase in the number of bits used for resource allocation signaling in the DL grants.

### Example 2

As another alternative one may allow for the N_{RB}_{_{—}}ₑₓₜ^{DL} parameter to obtain even larger values as shown in the Table in FIG. 5, while keeping the RBG size P the same as with the nominal Rel. 8 system bandwidth. This enables an even more flexible selection of the operating bandwidth. For example, with a 10 MHz system BW the N_{RB}_{_{—}}ₑₓₜ^{DL} parameter may have a value as large as 74, while the value of P is maintained as 3. This makes it possible to realize any BW between 6 and 110 RBs. Note that in the Table of FIG. 5 the reference to “Rel'9” is intended to represent beyond Rel. 8, e.g., Rel. 9, Rel. 10 or an advanced LTE (LTE-A) implementation.

There are at least two alternative techniques for implementing the exemplary embodiments of this invention.

In a first technique the beyond Rel. 8 UE 10 may always have the resource allocation in the DL grant such that flexible DL resource allocation signaling is supported, i.e., N_{RB}_{_{—}}ₑₓₜ^{DL} may be set to a fixed value for each system bandwidth option in the specification. This implies that the DL resource allocation for a beyond Rel. 8 UE 10 would be accomplished assuming that N_{RB}_{_{—}}ₑₓₜ^{DL} PRBs are available.

In a second technique the N_{RB}_{_{—}}ₑₓₜ^{DL} parameter may be configured on, for example, the cell level. Using higher layer signaling (e.g., RRC signaling) the network 1 can indicate to the UE 10 whether it should expect to receive conventional Rel. 8 DL grants, or whether it should expect to receive advanced grants with more flexible resource allocation signaling. In other words the value of the NR_{RB}_{_{—}}ₑₓₜ^{DL} parameter would depend on the higher layer signaling.

Furthermore, it is possible to select the value for N_{RB}_{_{—}}ₑₓₜ^{DL} from several alternatives so as to optimize usage for various different BWs.

The Table shown in FIG. 5 lists possible exemplary values for N_{RB}_{_{—ext}}^{DL} that can be used for defining the resource allocation field to be used with new DCI formats. The second column from the right shows the bandwidths that can be supported with these values with the granularity of one resource block. The last column shows how many bits are added to the PDCCH resource allocation field for each system BW. It is noted that although the resource allocation overhead increases slightly, the overall increase in the PDCCH overhead is still relatively small when all fields and the CRC are taken into account.

RS support is provided to beyond Rel. 8 UEs 10 that may be expected to estimate the wireless channel over the extended bandwidth prior to demodulation of any data transmitted over the extended spectrum. For this purpose Rel. 8 cell-specific reference symbols are extended in order to cover the frequency range of the N_{RB}_{_{—}}ₑₓₜ^{DL} RBs, as opposed to the range of the N_{RB}^{DL} RBs in the Rel. 8 system.

The current Rel.-8 specifications (3GPP TS 36.211 v8.3.0) allow for an extension of RSs over a wider system bandwidth in a backward compatible manner for Rel. 8 terminals. The reference signal design in 3GPP TS 36.211 v8.3.0, Section 6.10.1.2 is such that, prior to being mapped to REs, the RS sequence is always read from indices ranging from N_{RB}^{max, DL}−N_{RB}^{max, DL}+N_{RB}^{DL}−1, where N_{RB}^{max, DL}=110 RBs is the largest specified DL bandwidth (see again 3GPP TS 36.211 v8.3.0, Section 6.2.1).

Assuming now that the new parameter N_{RB}_{_{—}}ₑₓₜ^{DL} is used in place of N_{RB}^{DL} for mapping RSs to REs, as described in the current specifications, there is achieved a RS mapping over N_{RB}_{_{—}}ₑₓₜ^{DL} RBs. If the BW is extended in a symmetrical manner, i.e., half on each side around the Rel. 8 system BW, then the described mapping of RSs to REs results in a specification-compliant mapping for both a Rel. 8 UE 10 that accesses the center BW with N_{RB}^{DL} RBs, and a beyond Rel. 8 UE 10 that accesses a BW of N_{RB}_{_{—}}ₑₓₜ^{DL} RBs.

Asymmetrical BW allocations, if used, may be realized by introducing additional signaling to indicate the location (above or below the center frequency) of the extended RBs. Specific RS sequences are preferably designed to allow for channel estimation over the extended portions of BW in the case of an asymmetrical allocation.

As the PDSCH bandwidth is extended, the bandwidth covered in the CQI reporting is preferably increased as well. The current CQI reporting mechanisms may be readily extended to provide support for the enhanced BW allocation in accordance with this invention by simply increasing the number of reported and measured subbands to cover those frequencies outside of the system bandwidth

Receive filtering at the UE 10 may set some practical restrictions on the flexibility of the supported bandwidths. The UE 10 may be equipped with a receive filter that can be configured to a certain set of bandwidths, for example in LTE there are six possible bandwidths to which the receive filter can be tuned. Hence, in practice, the beyond Rel. 8 UE 10 UE 10 operates with a defined a set of additional bandwidths.

These exemplary embodiments provide a number of advantages and technical effects, such as allowing a network operator to efficiently utilize available spectrum with much finer granularity than is allowed in LTE Rel. 8. Further, the incorporation of these exemplary embodiments can be accomplished with but simple modifications to the existing standardization.

Based on the foregoing it should be apparent that the exemplary embodiments of this invention provide a method, apparatus and computer program(s) to provide an enhanced resource allocation for a user equipment that includes a wider system bandwidth. Referring to FIG. 6, in accordance with a method, and a result of execution of computer program instructions, at Block 6A there is a step of forming a resource allocation for a particular system bandwidth, where the resource allocation comprises a larger number of resource blocks than a maximum number of resource blocks associated with the particular system bandwidth, while maintaining a same resource block group size as would be present with the maximum number of resource blocks with the particular system bandwidth. The step of forming comprises use of an extended parameter in a derivation of the resource allocation. At Block 6B there is a step of transmitting information descriptive of the resource allocation to user equipment.

The various blocks shown in FIG. 6 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, and as was noted above, it should be appreciated that at least some aspects of the exemplary embodiments of the inventions may be practiced in various components such as integrated circuit chips and modules.

It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, and as was noted above, the exemplary embodiments apply as well to UL resource allocations and, in this case, there is introduced the new parameter that may be referred to for convenience as N_{RB}_{_{—}}ₑₓₜ^{UL} and that is used to indicate how many UL RBs can be assigned with the UL grant in the PDCCH. The various descriptions provided above with respect to the use of the N_{RB}_{_{—}}ₑₓₜ^{DL} parameter apply as well to the use of the N_{RB}_{_{—}}ₑₓₜ^{UL} parameter.

It should be further noted that the UL BW may be equal to the DL BW, or the UL BW may be different than the DL BW. In either case the exemplary embodiments of this invention may be used to provide the above-noted advantages and technical effects.

Note that in some cases then there may be one or more than one extended parameters that need to be signaled to the RARU 10E of the UE 10 (depending on whether the bandwidth extension occurs in the DL, in the UL, or in both the DL and the UL). As was indicated above, this signaling may occur in a MIB, in a SIB and/or by RRC signaling, as non-limiting examples.

Further by example, the use of these exemplary embodiments can enable the Rel. 8 TBS tables to be used as they are by reading an entry corresponding to a selected MCS and the number of allocated PRBs, or new TBS tables may be defined if higher peak data rates are desired.

Further by example, and as was noted above, the BW extension made possible by the use of these exemplary embodiments may be cell-specific or it may be UE-specific.

Further by example, in order to mitigate any possible non-use of control channel BW, one may extend the PDSCH portion of the additional PDSCH PRBs to also span the first OFDM symbols.

Further by example, while the exemplary embodiments have been described above in the context of the EUTRAN (UTRAN-LTE) system and enhancements and updates thereto, it should be appreciated that the exemplary embodiments of this invention are not limited for use with only this one particular type of wireless communication system, and that they may be used to advantage in other wireless communication systems.

Clearly the use of the exemplary embodiments provides a further technical effect in that it enables beyond Rel. 8 UEs 10 to co-exist with Rel. 8 UEs in the same cell, while taking advantage of the extended resource allocation made possible by the exemplary embodiments.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., N_{RB}_{_{—}}ₑₓₜ^{DL}, N_{RB}_{_{—}}ₑₓₜ^{UL}, etc.) are not intended to be limiting in any respect, as these parameters may be identified by any suitable names. Further, the formulas and expressions that use these various parameters may differ from those expressly disclosed herein. Further, the various names assigned to different channels (e.g., PDCCH, PDSCH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
forming a resource allocation for a first system bandwidth that is larger than a second system bandwidth, where the resource allocation comprises a larger number of resource blocks than a maximum number of resource blocks associated with the second system bandwidth while maintaining a same resource block group size as would be present with the maximum number of resource blocks for the second system bandwidth, where forming comprises use of an extended parameter in a derivation of the resource allocation; and
transmitting information descriptive of the resource allocation to a mobile device.

2. The method of claim 1, where the extended parameter is one that expresses a downlink bandwidth configuration in multiples of a resource block size in the frequency domain, expressed as a number of frequency subcarriers.

3. The method of claim 1, where the extended parameter is one that expresses an uplink bandwidth configuration in multiples of a resource block size in the frequency domain, expressed as a number of frequency subcarriers.

4. (canceled)

5. (canceled)

6. The method of claim 2, where the extended parameter effectively scales a resource allocation field to provide a larger downlink system bandwidth than that provided by a second downlink system bandwidth of the second system bandwidth.

7. The method of claim 3, where the extended parameter effectively scales a resource allocation field to provide a larger uplink system bandwidth than that provided by a second uplink system bandwidth of the second system bandwidth.

8. The method of claim 2, where the particular downlink system bandwidth is about 1.4 MHz, and where the larger downlink system bandwidth that is provided is in a range of about 1.4 MHz to about 2.8 MHz, or where the particular downlink system bandwidth is about 3 MHz, and where the larger downlink system bandwidth that is provided is in a range of about 3 MHz to about 4.8 MHz, or where the particular downlink system bandwidth is about 5 MHz, and where the larger downlink system bandwidth that is provided is in a range of about 5 MHz to about 9.8 MHz, or where the particular downlink system bandwidth is about 10 MHz, and where the larger downlink system bandwidth that is provided is in a range of about 10 MHz to about 14.8 MHz, or where the particular downlink system bandwidth is about 15 MHz, and where the larger downlink system bandwidth that is provided is in a range of about 15 MHz to about 19.8 MHz, or where the particular downlink system bandwidth is about 20 MHz, and where the larger downlink system bandwidth is greater than 20 MHz.

9-13. (canceled)

14. The method of claim 3, where the particular uplink system bandwidth is about 1.4 MHz, and where the larger uplink system bandwidth that is provided is in a range of about 1.4 MHz to about 2.8 MHz, or where the particular downlink system bandwidth is about 3 MHz, and where the larger downlink system bandwidth that is provided is in a range of about 3 MHz to about 4.8 MHz, or where the particular downlink system bandwidth is about 5 MHz, and where the larger downlink system bandwidth that is provided is in a range of about 5 MHz to about 9.8 MHz, or where the particular downlink system bandwidth is about 10 MHz, and where the larger downlink system bandwidth that is provided is in a range of about 10 MHz to about 14.8 MHz, or where the particular downlink system bandwidth is about 15 MHz, and where the larger downlink system bandwidth that is provided is in a range of about 15 MHz to about 19.8 MHz, or where the particular downlink system bandwidth is about 20 MHz, and where the lamer downlink system bandwidth is greater than 20 MHz.

15-19. (canceled)

20. The method of claim 1, where the extended parameter is signaled to the mobile device using a master information block.

21. The method of claim 1, where the extended parameter is signaled to the mobile device using a system information block.

22. The method of claim 1, where the extended parameter is signaled to the mobile device using radio resource control signaling.

23. The method of claim 1, further comprising: receiving a channel quality indicator that comprises measurement information obtained from the first system bandwidth.

24. The method of claim 1, where the larger number of resource blocks are disposed symmetrically about the maximum number of resource blocks associated with the second system bandwidth.

25. The method of claim 1, where the larger number of resource blocks are disposed asymmetrically about the maximum number of resource blocks associated with the second system bandwidth.

26. A computer-readable memory medium storing program instructions, execution of the program instructions by an apparatus resulting in operations comprising:
forming a resource allocation for a first system bandwidth that is larger than a second system bandwidth, where the resource allocation comprises a larger number of resource blocks than a maximum number of resource blocks associated with the second system bandwidth while maintaining a same resource block group size as would be present with the maximum number of resource blocks for the second system bandwidth, where forming comprises use of an extended parameter in a derivation of the resource allocation; and
transmitting information descriptive of the resource allocation a mobile device.

27. The computer-readable memory medium of claim 26, where the extended parameter is one that expresses a downlink bandwidth configuration in multiples of a resource block size in the frequency domain, expressed as a number of frequency subcarriers, or where the extended parameter is one that expresses an uplink bandwidth configuration in multiples of a resource block size in the frequency domain, expressed as a number of frequency subcarriers.

28-34. (canceled)

35. The computer-readable memory medium of claim 26, where the extended parameter is signaled to the mobile device using a master information block, a system information block or radio resource control signaling.

36-40. (canceled)

41. An apparatus, comprising:
a resource allocation unit configured to form a resource allocation for a first system bandwidth that is larger than a second system bandwidth, where the resource allocation comprises a larger number of resource blocks than a maximum number of resource blocks associated with the second system bandwidth while maintaining a same resource block group size as would be present with the maximum number of resource blocks for the second system bandwidth, said resource allocation unit being further configured to use an extended parameter in a derivation of the resource allocation; and
a transmitter configured to transmit information descriptive of the resource allocation to a mobile device.

42-49. (canceled)

50. The apparatus of claim 41, where the extended parameter is signaled to the mobile device using a master information block, a system information block or radio resource control signaling.

51. (canceled)

52. (canceled)

53. The apparatus of claim 41, further comprising a receiver configured to receive a channel quality indicator that comprises measurement information obtained from the first system bandwidth.

54. (canceled)

55. The apparatus of claim 41, where said resource allocation unit is embodied at least partially in at least one integrated circuit.

56-63. (canceled)
